(19) United States
(12) Patent Application Publication
(10) Pub. No.: US 2013/0057335 A1
(43) Pub. Date: Mar. 7, 2013

(54) POWER SUPPLY STABILIZING CIRCUIT OF SOLID-STATE IMAGING DEVICE

(71) Applicants: Nobuhiro KAWAI, Fujisawa-shi (JP); Satoshi Sakurai, Kawasaki-shi (JP)

(72) Inventors: Nobuhiro KAWAI, Fujisawa-shi (JP); Satoshi Sakurai, Kawasaki-shi (JP)

(21) Appl. No.: 13/536,132

(22) Filed: Jun. 28, 2012

(30) Foreign Application Priority Data
Sep. 6, 2011 (JP) 2011-193757

(51) Int. Cl. G05F 5/00

(52) U.S. Cl. 327/537; 323/299

(57) ABSTRACT

According to one embodiment, a power supply stabilizing circuit includes at least one bias voltage generation circuit and at least one voltage supply circuit. The at least one bias voltage generation circuit is configured to compare a reference voltage and a signal corresponding to a bias voltage which is generated from an unstable voltage, thereby generating the bias voltage. The at least one voltage supply circuit is disposed near a functional circuit, is connected to the functional circuit by a wiring line, and is configured to stabilize the unstable voltage, based on the bias voltage which is supplied from the at least one bias voltage generation circuit, and to supply a stabilized voltage to the functional circuit.

### CROSS-REFERENCE TO RELATED APPLICATIONS

This application is based upon and claims the benefit of priority from prior Japanese Patent Application No. 2011-193757, filed Sep. 6, 2011, the entire contents of which are incorporated herein by reference.

### FIELD

Embodiments described herein relate generally to a power supply stabilizing circuit which is applied to, for example, a solid-state imaging device.

### BACKGROUND

In general, a solid-state imaging device including a two-dimensional pixel array simultaneously samples signals which are output from a plurality of horizontally arranged pixels, and A/D converts the signals. Thus, when noise is included in a power supply voltage of the solid-state imaging device, noise having a high correlation in the horizontal direction appears on an output image. Unlike noise appearing with no spatial correlation, the noise having the high correlation in the horizontal direction greatly affects the visual characteristics of a human. It is very important, therefore, in the designing of the solid-state imaging device to suppress the occurrence of this noise and prevent the noise from affecting the output image. However, conventionally, it has been difficult to reduce the power supply noise. This being the case, there is a demand for a power supply stabilizing circuit which can reduce noise and generate a stable voltage.

### BRIEF DESCRIPTION OF THE DRAWINGS

FIG. 1 is a circuit diagram which illustrates a power supply stabilizing circuit according to a first embodiment.

FIG. 2 is a circuit diagram which illustrates a power supply stabilizing circuit according to a second embodiment.

FIG. 3 is a diagram which illustrates an example of a solid-state imaging device to which the first and second embodiments are applied.

FIG. 4 is a diagram which illustrates an example in which the second embodiment is applied to a part of a solid-state imaging device.

FIG. 5 is a view which concretely illustrates the example of FIG. 4.

FIG. 6 is a diagram illustrating another example in which the second embodiment is applied to a part of a solid-state imaging device.

### DETAILED DESCRIPTION

In general, according to one embodiment, a power supply stabilizing circuit includes at least one bias voltage generation circuit and at least one voltage supply circuit. The at least one bias voltage generation circuit is configured to compare a reference voltage and a signal corresponding to a bias voltage which is generated from an unstable voltage, thereby generating the bias voltage. The at least one voltage supply circuit is disposed near a functional circuit, is connected to the functional circuit by a wiring line, and is configured to stabilize the unstable voltage, based on the bias voltage which is supplied from the at least one bias voltage generation circuit, and to supply a stabilized voltage to the functional circuit.

In general, a power supply stabilizing circuit is used in order to suppress noise of a power supply voltage which is applied to a solid-state imaging device. At this time, two cases are thinkable, one being the case where a device having a power supply stabilizing function is used separately from the solid-state imaging device, and the other being the case where a power supply stabilizing circuit is incorporated in the solid-state imaging device itself.

In the former case, the cost increases since a separate device is necessary and an area on a board has to be secured for mounting the separate device.

In the latter case, such configuration is generally adopted that an unstable power, which is supplied from the outside of the solid-state imaging device, is delivered to a power supply stabilizing circuit which is mounted in the solid-state imaging device and is thus stabilized, the power which is output from the power supply stabilizing circuit is supplied to a capacitor that is connected to the outside of the solid-state imaging device and is thus further stabilized, and the stabilized power is supplied to the solid-state imaging device. Thus, the capacitor and a terminal for connection to the capacitor are needed, and the solid-state imaging device and an imaging module, in which the solid-state imaging device is mounted, increase in size, leading to an increase in cost.

In addition, in this case, since the length of wiring from the power supply stabilizing circuit to the solid-state imaging device increases, there is a problem that the stabilized power is easily affected by disturbance noise.

As described above, it has been difficult to supply stabilized power to the solid-state imaging device.

Embodiments will be described hereinafter with reference to the accompanying drawings.

### FIRST EMBODIMENT

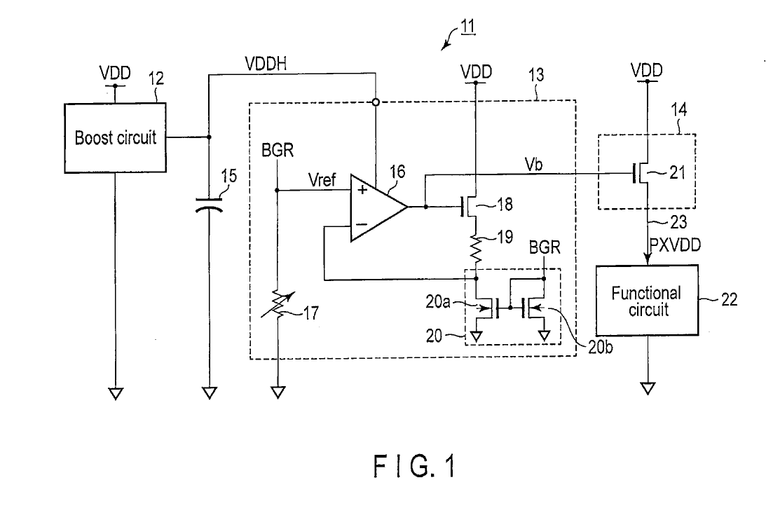

FIG. 1 illustrates a power supply stabilizing circuit 11 according to a first embodiment.

The power supply stabilizing circuit 11 includes, for example, a boost circuit 12, a bias voltage generation circuit 13, and a voltage supply circuit (hereinafter referred to as “regulator”) 14.

The boost circuit 12 is composed of, for example, a charge pump circuit. The boost circuit 12 boosts an unstable power supply voltage VDD which is supplied from the outside of the semiconductor device, and generates a voltage VDDH which is higher than the voltage VDD. An output terminal of the boost circuit 12 is grounded via, for example, a capacitor 15 which constitutes a smoothing circuit, and is also connected to the bias voltage generation circuit 13.

The bias voltage generation circuit 13 includes, for example, an operational amplifier 16, a variable resistor 17, an N-channel MOS transistor (hereinafter referred to as “NMOS transistor”) 18, a resistor 19 and a current source 20.

The voltage VDDH, which has been generated by the boost circuit 12, is supplied to the operational amplifier 16 as supply power to the operational amplifier 16. A reference voltage Vref is supplied to a non-inversion input terminal of the operational amplifier 16. The reference voltage Vref is generated by adjusting, by the variable resistor 17, a stable fixed voltage (reference voltage) which is generated by a band-gap reference (BGR) circuit (not shown). A voltage at a connection node between the resistor 19 and the current source 20 is supplied as a negative feedback voltage to an inversion input terminal of the operational amplifier 16.

Specifically, a bias voltage Vb, which is output from an output terminal of the operational amplifier 16, is supplied to the gate of the NMOS transistor 18. An unstable power supply voltage VDD, which is supplied from the outside, is supplied to the drain of the NMOS transistor 18. The source of the NMOS transistor 18 is connected to the current source 20 via the resistor 19. The current source 20 is composed of two NMOS transistors 20a and 20b which constitute a current mirror circuit. The voltage generated by the BGR circuit is supplied to the drain and gate of the NMOS transistor 20b and to the gate of the NMOS transistor 20a, and the current flowing in the NMOS transistor 20b is mirrored in the NMOS transistor 20a. A voltage corresponding to a bias voltage, which is output from the connection node between the current source 20 and the resistor 19, is supplied as a negative feedback voltage to the inversion input terminal of the operational amplifier 16.

The operational amplifier 16 operates in a manner to minimize a potential difference between the reference voltage Vref and the negative feedback voltage, and outputs a bias voltage Vb. Specifically, based on the voltage that is supplied from the boost circuit 12, the bias voltage generation circuit 13 generates the bias voltage Vb which is not affected by the fluctuation of the unstable power supply voltage VDD.

The bias voltage Vb, which has been generated by the bias voltage generation circuit 13, is supplied to the gate of an NMOS transistor 21 which constitutes the voltage supply circuit 14. The unstable power supply voltage VDD is supplied to the drain of the NMOS transistor 21, and the source of the NMOS transistor 21 is connected to a functional circuit 22 via a wiring line 23.

The stable bias voltage Vb, which is output from the bias voltage generation circuit 13 and is not affected by the fluctuation of the power supply voltage VDD, is supplied to the gate of the NMOS transistor 21. Thus, a stabilized voltage PXVDD is output from the source of the NMOS transistor 21, and this voltage PXVDD is supplied via the wiring line 23 to the functional circuit 22, for instance, a pixel module of a solid-state imaging device.

The NMOS transistor 21 which constitutes the regulator 14 is disposed near the functional circuit 22. Thus, the length of the wiring line 23 can be decreased. Therefore, it is possible to avoid mixing of noise from the outside into the wiring line 23, to avoid mixing of power supply noise into the functional circuit 22, and to eliminate the effect of noise.

In the meantime, the reference voltage Vref can be varied by adjusting the variable resistor 17.

As has been described above, the part that generates the negative feedback voltage is composed of the current source 20, resistor 19 and NMOS transistor 18. In order to suppress the effect due to variance in fabrication of transistors, the current source 20 and transistor 18 constitute such a replica circuit as to have a ratio which is equal to the ratio between the current consumed in the function circuit 22 and the size of the NMOS transistor 21 that constitutes the regulator 14.

The resistor 19 is a resistor for decreasing the negative feedback voltage, and has the effect that the reference voltage Vref can be lowered by decreasing the negative feedback voltage. Specifically, in the case where the resistor 19 is absent, the reference voltage Vref has to be set to be equal to the stabilized voltage PXVDD which is supplied to the functional circuit 22. In the case where the voltage PXVDD is to be set to be slightly lower than the unstable power supply voltage VDD, for example, VDD=2.8 V and PXVDD=2.6 V, the reference voltage Vref is 2.6 V. In particular, an allowance for the power supply voltage on the BGR circuit side which supplies current to the variable resistor 17 becomes deficient, and there is concern that a fixed current cannot be supplied. Similarly, an allowance for the power supply voltage of the operational amplifier 16 becomes deficient, and the operational amplifier 16 fails to function. In order to avoid this, the resistor 19 is inserted to decrease the negative feedback voltage, so that the reference voltage Vref may become sufficiently lower than the unstable power supply voltage VDD.

By the above-described structure, the bias voltage Vb is output from the output terminal of the operational amplifier 16. The bias voltage Vb can be varied by adjusting the variable resistor 17. In addition, the voltage PXVDD, which is output from the regulator 14, can be varied by varying the bias voltage Vb. Therefore, the voltage PXVDD can be varied in accordance with the voltage which is needed by the functional circuit 22.

In the meantime, the NMOS transistor 21 of the regulator 14 can be designed with a proper size corresponding to a current load, within the range of a voltage drop which can be tolerated with respect to the current consumed by the functional circuit 22 that is a load. However, as described above, such designing is necessary that the ratio between the consumption current of the functional circuit 22 and the size of the NMOS transistor 21 of the regulator 14 may become equal to the ratio between the current of the current source 20 and the size of the NMOS transistor 18.

According to the first embodiment, the bias voltage Vb, which cancels the fluctuation of the unstable power supply voltage VDD, is supplied from the bias voltage generation circuit 13 to the gate of the NMOS transistor 21 which constitutes the regulator 14. Thus, the stabilized voltage PXVDD is supplied from the source of the NMOS transistor 21 via the wiring line 23 to, for example, a pixel module of a solid-state imaging device, which serves as the functional circuit 22.

Moreover, the NMOS transistor 21 which constitutes the regulator 14 is disposed near, for example, the pixel module of the solid-state imaging device, which serves as the functional circuit 22. Therefore, the length of the wiring line 23 can be decreased, and it is possible to prevent mixing of noise, and to reduce the effect of noise on the pixel module.

### SECOND EMBODIMENT

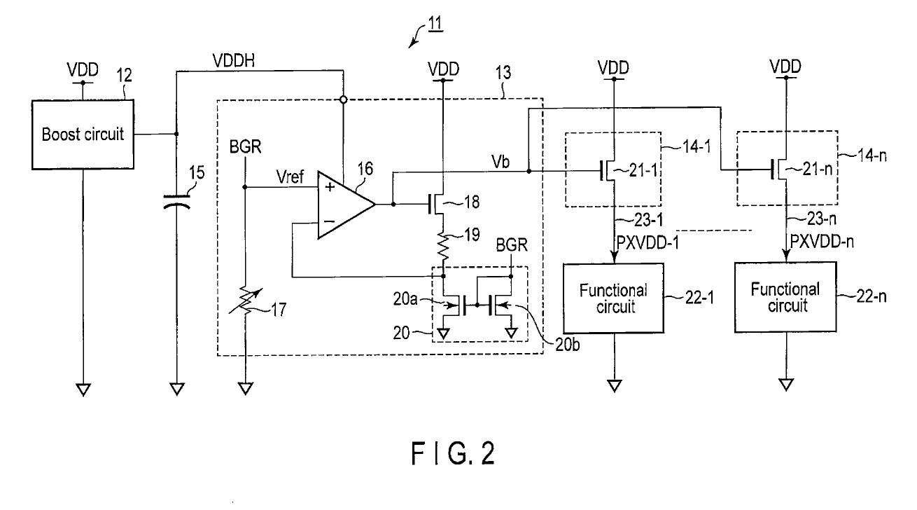

FIG. 2 illustrates a power supply stabilizing circuit 11 according to a second embodiment. In the second embodiment, the same parts as in the first embodiment are denoted by like reference numerals, and only different parts are described.

In the second embodiment, regulators 14-1 to 14-n are disposed in association with a plurality of functional circuits 22-1 to 22-n, and the sources of NMOS transistors 21-1 to 21-n, which constitute the regulators 14-1 to 14-n, are connected to the functional circuits 22-1 to 22-n via wiring lines 23-1 to 23-n. The bias voltage Vb is supplied from the bias voltage generation circuit 13 to the gates of the NMOS transistors 21-1 to 21-n.

According to this structure, even in the case where the plural functional circuits 22-1 to 22-n are disposed at discrete positions within the semiconductor device, the regulators 14-1 to 14-n can be disposed near the respective functional circuits 22-1 to 22-n. Therefore, the length of the wiring lines 23-1 to 23-n can be decreased, and it is possible to prevent mixing of noise.

In addition, even in the case where the consumption current differs between the functional circuits 22-1 to 22-n, since the ratio between the current in each functional circuit, 22-1 to 22-n, and the size of the NMOS transistor, 21-1 to 21-n, in the associated regulator, 14-1 to 14-n, is made equal to the ratio between the current of the current source 20 and the size of the NMOS transistor 18 in the bias voltage generation circuit 13, stabilized power supply voltages PXVDD-1 to PXVDD-n can be set at the same level.

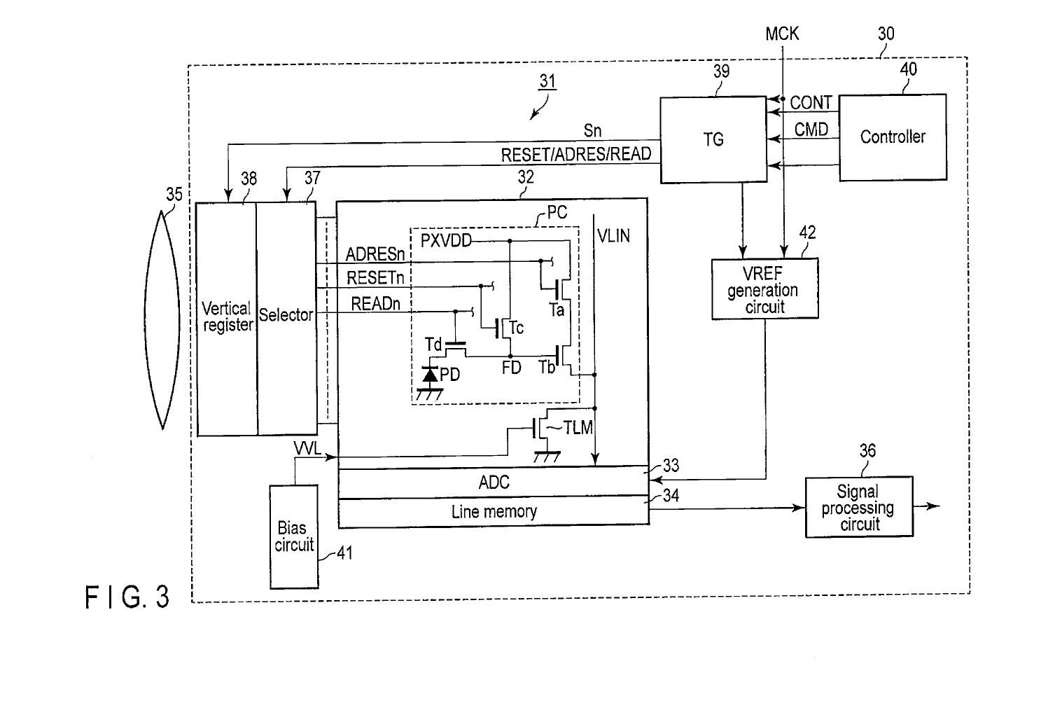

FIG. 3 schematically illustrates an example of a solid-state imaging device 30 to which the first and second embodiments are applied, for instance, a CMOS (Complementary Metal Oxide Semiconductor) type solid-stage imaging device which is applied to, e.g. a digital cameral or a digital video camera.

A sensor core module 31 includes a pixel module 32, an analog/digital conversion circuit (ADC) 33 of, e.g. a column parallel type, and a line memory 34.

The pixel module 32 photoelectrically converts light which is incident via a lens 35, and generates a charge corresponding the amount of incident light. In the pixel module 32, a plurality of cells (pixels) are arranged in a matrix on a semiconductor substrate (not shown). One cell PC is composed of four transistors (Ta, Tb, Tc, Td) and a photodiode (PD). Pulse signals ADRESn, RESETn and READn are supplied to each cell. The transistor Tb of each cell PC is connected to a vertical signal line VLIN. One end of the current path of a load transistor TLM for a source-follower circuit is connected to the vertical signal line VLIN, and the other end of the current path is grounded.

An analog signal corresponding to a signal charge, which is generated by the pixel module 32, is supplied to the ADC 33 and converted to a digital signal. The digital signal, which has been output from the ADC 33, is successively transferred via the line memory 34. A digital signal of, e.g. 10 bits, which has been read out of the line memory 34, is processed by a signal processing circuit 36.

A pulse selector circuit (selector) 37 and a vertical register 38 for, e.g. signal read, are disposed in the neighborhood of the pixel module 32.

A timing generator (TG) 39 generates pulse signals, such as RESET/ADRES/READ and Sn, in response to a control signal CONT and a command CMD, which are supplied from a controller 40.

The pulse signal RESET/ADRES/READ is supplied to the selector 37, and the pulse signal Sn is supplied to the vertical register 38. The vertical register 38 selects a vertical line of the pixel module 32, and the pulse signal RESET/ADRES/READ (FIG. 3 representatively illustrates RESETn, ADRESn and READn) is supplied to the pixel module 32 via the selector 37.

In the cell PC, the current paths of the row select transistor Ta and amplification transistor Tb are connected in series between a power supply PXVDD and the vertical signal line VLIN. The pulse signal (address pulse) ADRESn is supplied to the gate of the transistor Ta. The current path of the reset transistor Tc is connected between the power supply PXVDD and the gate of the transistor Tb (detection portion FD), and the pulse signal (reset pulse) RESETn is supplied to this gate. In addition, one end of the current path of the read transistor Td is connected to the detection portion FD, and the pulse signal (read pulse) READn is supplied to the gate of the read transistor Td. The cathode of the photodiode PD is connected to the other end of the current path of the transistor Td, and the anode of the photodiode PD is grounded. Further, a bias voltage VVL from a bias circuit 41 is applied to the pixel module 32. The bias voltage VVL is supplied to the gate of the load transistor TLM.

A reference voltage (VREF) generation circuit 42 generates a reference waveform for the ADC 33, responding to a main clock signal MCK. The VREF generation circuit 42 generates a ramp wave VREF and supplies it to the ADC 33, for example, in order to execute AD conversion in one horizontal scanning period.

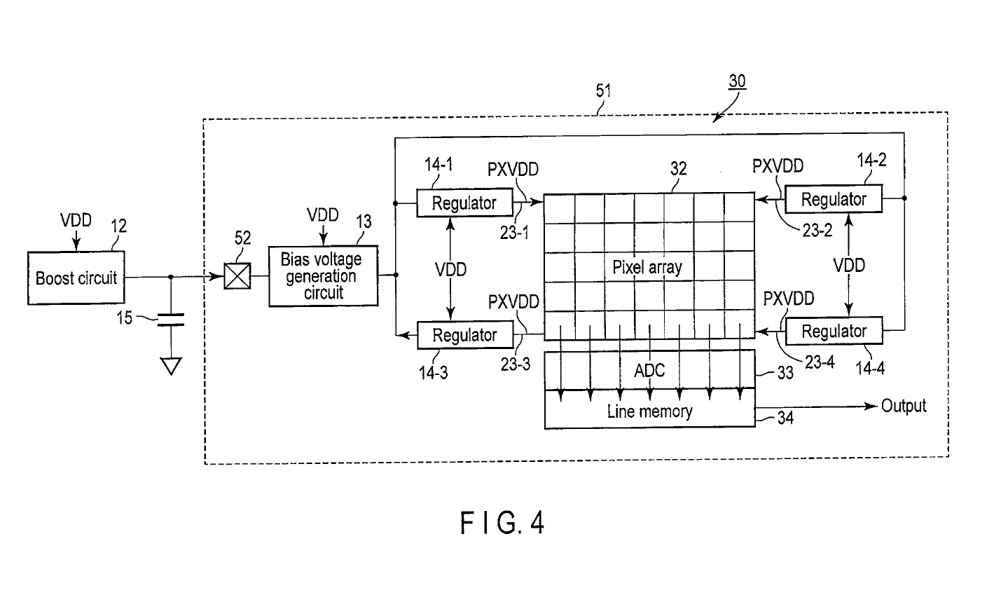

FIG. 4 illustrates an example in which the second embodiment is applied to the pixel module 32 shown in FIG. 3. In FIG. 4, the same parts as in the second embodiment are denoted by like reference numerals.

Regulators 14-1 to 14-4 are connected to the pixel module 32 serving as the functional circuit. Voltages PXVDD, which are output from the regulators 14-1 to 14-4, are supplied as power to each cell PC shown in FIG. 3. The regulators 14-1 to 14-4 are disposed near the pixel module 32, and the length of wiring lines 23-1 to 23-4, which connect the regulators 14-1 to 14-4 and the pixel module 32, is decreased.

In FIG. 4, the bias voltage generation circuit 13 and regulators 14-1 to 14-4 are formed in the same semiconductor chip 51 as the solid-state imaging device 30, and the boost circuit 12 and capacitor 15 are connected, for example, to the outside of the semiconductor chip 51. The boost circuit 12 and capacitor 15 are connected to a terminal 52 which is provided on the semiconductor chip 51, and the bias voltage generation circuit 13 is connected to the terminal 52.

According to the above-described structure, the regulators 14-1 to 14-4 are disposed near the pixel module 32, and the length of the wiring lines 23-1 to 23-4, which connect the regulators 14-1 to 14-4 and the pixel module 32, is decreased. Thus, since the voltage

PXVDD, which is stabilized by the regulator, 14-1 to 14-4, can be supplied to the pixel module 32 via the short wiring line, 23-1 to 23-4, the effect of noise can be eliminated and a good image signal can be obtained.

Moreover, since the regulators 14-1 to 14-4 and bias voltage generation circuit 13, which constitute the power supply stabilizing circuit, are incorporated in the semiconductor chip 51, the number of capacitors for power supply stabilization and the number of terminals for the capacitors can be reduced. For example, the size of the semiconductor chip 51 functioning as the solid-state imaging device, and the size of the imaging module in which the semiconductor chip 51 is amounted, can be reduced, and the cost can be reduced.

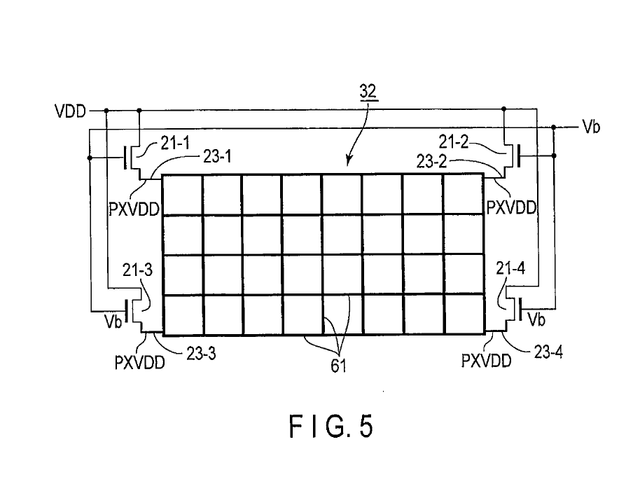

FIG. 5 concretely illustrates the relationship between the pixel module 32 of FIG. 4 and the NMOS transistors 21-1 to 21-4 which constitute the regulators 14-1 to 14-4. In the pixel module 32, a power supply wiring 61 for supplying voltages PXVDD is arranged, for example, in a mesh shape. The mesh-like power supply wiring 61 is disposed over the entire surface of the pixel module 32. In the case of a solid-state imaging device of a top-surface-illumination type, the power supply wiring 61 has to be configured to minimize blocking of a light path. However, in the case of a solid-state imaging device of a bottom-surface-illumination type, it is not necessary to take the light path into account, so the degree of freedom of arrangement of the power supply wiring 61 is high. In any case, the configuration of the power supply wiring 61 is not limited to the mesh shape, and it should suffice if the power supply wiring 61 is arranged over the entire surface of the pixel module 32 and the power supply wiring 61 has such a shape as to be able to supply power to the respective cells PC.

The sources of the NMOS transistors 21-1 to 21-4 are connected to, for example, the four corners of the power supply wiring 61. However, the sources may not be connected to the four corners, and it should suffice if the power supply voltages PXVDD can be supplied from the periphery of the power supply wiring 61.

As described above, the voltage PXVDD is supplied from at least the four corners of the power supply wiring 61. Thereby, for example, compared to the case where the power is supplied from only one side of the power supply wiring 61, the voltage PXVDD can be uniformly supplied to the entire area of the pixel module 32. Specifically, in the case where the power is supplied from only one side of the power supply wiring 61, the power supply voltage lowers in a part which is distant from the power supply part, and a signal that is output from the pixel module 32 decreases, resulting in such influence that the brightness of the output image lowers and non-uniformity occurs in brightness of the output image. By contrast, in the case where the power is supplied from at least the four corners of the pixel module 32, the voltage of a uniform level can be supplied to the pixel module 32. Therefore, the brightness of the output image can be made uniform.

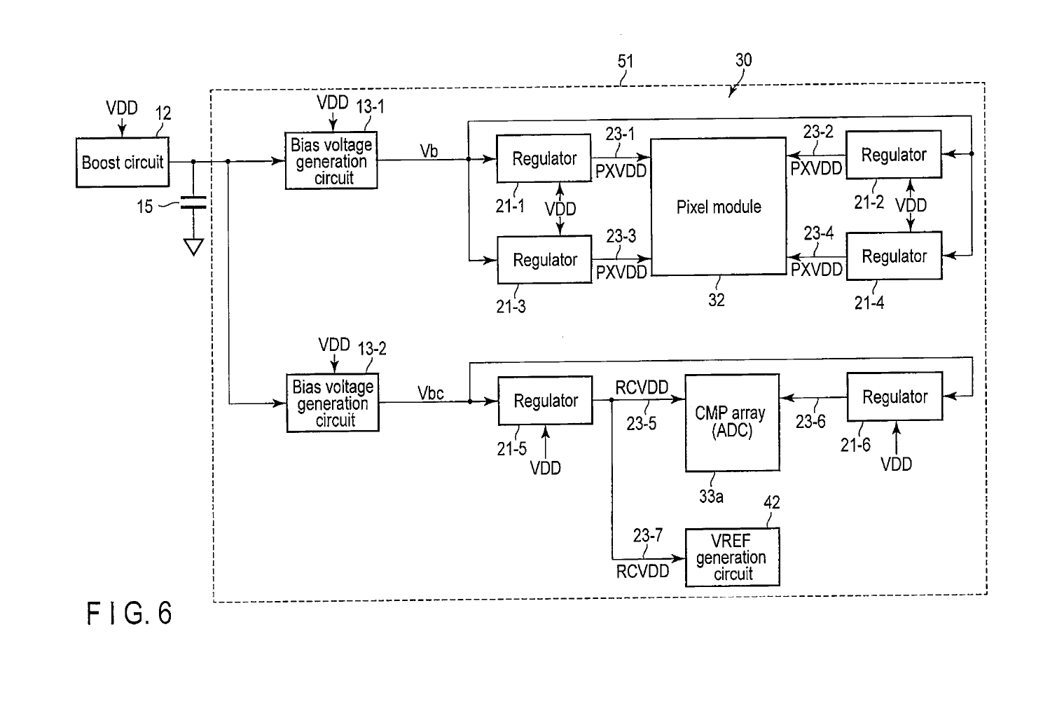

FIG. 6 illustrates a modification of the second embodiment. In this modification, the second embodiment is applied to the pixel module 32, ADC 33 and VREF generation circuit 42 which are shown in FIG. 3.

In FIG. 6, the voltage that is supplied to the pixel module 32 differs from the voltage which is supplied to the ADC 33 and VREF generation circuit 42. Thus, two bias voltage generation circuits 13-1 and 13-2 are provided. The bias voltage generation circuit 13-1 supplies a bias voltage to regulators 21-1 to 21-4 which are disposed near the pixel module 32. The bias voltage generation circuit 13-2 supplies a bias voltage to regulators 21-5 to 21-7 which are disposed near the ADC 33 and VREF generation circuit 42.

The regulators 21-1 to 21-4 are connected to the pixel module 32 by wiring lines 23-1 to 23-4. The regulators 21-5 and 21-6 are connected to a comparator (CMP) array 33a, a CMP bias 33b and a CMP driver 33c, which constitute the ADC 33, by wiring lines 23-5 and 23-6. The regulator 21-5 is connected to the VREF generation circuit 42 by a wiring line 23-7.

According to the above-described structure, the bias voltage generation circuit 13-1 generates a bias voltage Vb for the pixel module 32, and the bias voltage generation circuit 13-2 generates a bias voltage Vbc for the ADC 33 and VREF generation circuit 42. Thus, the regulators 21-1 to 21-4 can supply a proper power supply voltage PXVDD to the pixel module 32, and the regulators 21-5 and 21-6 can supply a proper power supply voltage RCVDD to the ADC 33 and VREF generation circuit 42.

Moreover, since the regulators 21-1 to 21-4, 21-5 and 21-6 are disposed near the pixel module 32, ADC 33 and VREF generation circuit 42, the wiring length of the wiring lines 23-1 to 23-7 for connecting the pixel module 32, ADC 33 and VREF generation circuit 42 can be decreased. Thus, it is possible to prevent noise from mixing in the wiring lines 23-1 to 23-7. Therefore, it is possible to prevent noise having a high correlation in the horizontal direction from occurring in the output image, and the image quality can be enhanced.

In the first and second embodiments, the pixel module and ADC, which constitute the solid-state imaging device, are taken as examples of the functional circuit. However, the functional circuit is not limited to these examples, and the first and second embodiments can be applied to functional circuits other than the solid-state imaging device.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A power supply stabilizing circuit comprising:
at least one bias voltage generation circuit configured to compare a reference voltage and a signal corresponding to a bias voltage which is generated from an unstable voltage, thereby generating the bias voltage; and
at least one voltage supply circuit disposed near a functional circuit and connected to the functional circuit by a wiring line, the at least one voltage supply circuit being configured to stabilize the unstable voltage, based on the bias voltage which is supplied from the at least one bias voltage generation circuit, and to supply a stabilized voltage to the functional circuit.

2. The circuit according to claim 1, wherein the at least one voltage supply circuit comprises a first transistor having a current path with one end supplied with the unstable voltage and the other end connected to the functional circuit, and having a gate electrode supplied with the bias voltage.

3. The circuit according to claim 1, wherein the at least one bias voltage generation circuit comprises:
an operational amplifier configured to compare a reference voltage and a negative feedback voltage and to output a bias voltage; and
a negative feedback voltage generation circuit connected to an output terminal of the operational amplifier and configured to generate the negative feedback voltage.

4. The circuit according to claim 3, wherein the negative feedback voltage generation circuit comprises:
a second transistor including a gate electrode and a current path having one end and the other end, the gate electrode being connected to the output terminal of the operational amplifier, and the one end of the current path being supplied with the unstable voltage;
a resistor having one end and the other end, the one end of the resistor being connected to the other end of the current path of the second transistor; and
a current source connected to the other end of the resistor.

5. The circuit according to claim 4, wherein a ratio of a size of the second transistor and a current of the current source is equal to a ratio of a size of the first transistor which constitutes the voltage supply circuit and a current consumed by the functional circuit.

6. The circuit according to claim 5, wherein the functional circuit comprises a pixel module of a solid-state imaging device.

7. The circuit according to claim 6, wherein the at least one voltage supply circuit is connected to a periphery of the pixel module by the wiring line.

8. The circuit according to claim 7, further comprising a power supply wiring which is arranged over an entire surface of the pixel module.

9. The circuit according to claim 8, wherein the at least one voltage supply circuit is disposed at a periphery of the pixel module, and configured to supply a stabilized voltage to the power supply wiring from the periphery of the pixel module.

10. The circuit according to claim 9, wherein the functional circuit further comprises:
an analog/digital conversion circuit configured to convert an output signal of the pixel module to a digital signal; and
a reference voltage generation circuit configured to generate a reference voltage of the analog/digital conversion circuit,
wherein the at least one voltage supply circuit is disposed near the pixel module, the analog/digital conversion circuit and the reference voltage generation circuit, and is connected to the pixel module, the analog/digital conversion circuit and the reference voltage generation circuit by the wiring line.

11. The circuit according to claim 10, wherein the at least one bias voltage generation circuit comprises:
a first bias voltage generation circuit configured to generate a first bias voltage, and a second bias voltage generation circuit configured to generate a second bias voltage which is different from the first bias voltage,
wherein the first bias voltage generation circuit is configured to supply the first bias voltage to the voltage supply circuit which is disposed near the pixel module, and the second bias voltage generation circuit is configured to supply the second bias voltage to the voltage supply circuit which is disposed near the analog/digital conversion circuit and the reference voltage generation circuit.

12. A power supply stabilizing circuit of a solid-state imaging device, comprising:
at least one bias voltage generation circuit configured to compare a reference voltage and a signal corresponding to a bias voltage which is generated from an unstable voltage, thereby generating the bias voltage;
a pixel module of the solid-state imaging device; and
at least one voltage supply circuit disposed near the pixel module and connected to the pixel module by a wiring line, the at least one voltage supply circuit being configured to stabilize the unstable voltage, based on the bias voltage which is supplied from the at least one bias voltage generation circuit, and to supply a stabilized voltage to the pixel module.

13. The circuit according to claim 12, wherein the at least one voltage supply circuit comprises a first transistor having a current path with one end supplied with the unstable voltage and the other end connected to the pixel module, and having a gate electrode supplied with the bias voltage.

14. The circuit according to claim 12, wherein the at least one bias voltage generation circuit comprises:
an operational amplifier configured to compare a reference voltage and a negative feedback voltage and to output a bias voltage; and
a negative feedback voltage generation circuit connected to an output terminal of the operational amplifier and configured to generate the negative feedback voltage.

15. The circuit according to claim 14, wherein the negative feedback voltage generation circuit comprises:
a second transistor including a gate electrode and a current path having one end and the other end, the gate electrode being connected to the output terminal of the operational amplifier, and the one end of the current path being supplied with the unstable voltage;
a resistor having one end and the other end, the one end of the resistor being connected to the other end of the current path of the second transistor; and
a current source connected to the other end of the resistor.

16. The circuit according to claim 15, wherein a ratio of a size of the second transistor and a current of the current source is equal to a ratio of a size of the first transistor which constitutes the voltage supply circuit and a current consumed by the functional circuit.

17. The circuit according to claim 16, further comprising a power supply wiring which is arranged over an entire surface of the pixel module.

18. The circuit according to claim 17, wherein the at least one voltage supply circuit is disposed at a periphery of the pixel module, and configured to supply a stabilized voltage to the power supply wiring from the periphery of the pixel module.

19. The circuit according to claim 18, wherein the solid-state imaging device further comprises:
an analog/digital conversion circuit configured to convert an output signal of the pixel module to a digital signal; and
a reference voltage generation circuit configured to generate a reference voltage of the analog/digital conversion circuit,
wherein the at least one voltage supply circuit is disposed near the pixel module, the analog/digital conversion circuit and the reference voltage generation circuit, and is connected to the pixel module, the analog/digital conversion circuit and the reference voltage generation circuit by the wiring line.

20. The circuit according to claim 19, wherein the at least one bias voltage generation circuit comprises:
a first bias voltage generation circuit configured to generate a first bias voltage, and a second bias voltage generation circuit configured to generate a second bias voltage which is different from the first bias voltage,
wherein the first bias voltage generation circuit is configured to supply the first bias voltage to the voltage supply circuit which is disposed near the pixel module, and the second bias voltage generation circuit is configured to supply the second bias voltage to the voltage supply circuit which is disposed near the analog/digital conversion circuit and the reference voltage generation circuit.
